(19) United States
(12) Patent Application Publication
(10) Pub. No.: US 2006/0018109 A1
(43) Pub. Date: Jan. 26, 2006

(54) Display apparatus for vehicle

(75) Inventors: Hideaki Kageyama, Shizuoka (JP); Yoshiyuki Furuya, Shizuoka (JP); Takeshi Harada, Shizuoka (JP); Koji Ishii, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 11/182,742

(22) Filed: Jul. 18, 2005

(30) Foreign Application Priority Data
Jul. 21, 2004 (JP) 2004-212596

(51) Int. Cl. G01D 11/28

(52) U.S. Cl. 362/23; 362/326

(57) ABSTRACT

A display apparatus for a vehicle includes a display device on which a state of the vehicle is displayed using a desired design pattern; and a transparent auxiliary member interposed between the display device and a vehicle driver. The transparent auxiliary member has an auxiliary design pattern corresponding to a vehicle type to form a part of the desired design pattern by superposing thereon, and allows the vehicle driver to see superposed design pattern displayed on the display device and the auxiliary design pattern. Transmitted light emitted from the display device illuminates the transparent auxiliary member.

### BACKGROUND OF THE INVENTION

The priority application claims priority of Japanese Patent Application No. 2004-212596, which is hereby incorporated by reference.

### FIELD OF THE INVENTION

This invention relates to a display apparatus to be mounted on a vehicle, and in particular, the display apparatus having a display device for displaying a state of a vehicle with a desired design pattern, said vehicle on which the display apparatus is mounted.

### DESCRIPTION OF THE RELATED ART

Generally, a display apparatus is mounted on a vehicle for displaying vehicle speed, engine revolutions, and the like. The display apparatus for a vehicle includes: a dial plate having indexes such as graduations, numbers or symbols on a surface thereof; a pointer disposed in front of the dial plate; an inner machinery for driving the pointer corresponding to measured data; and a wiring board on which a circuit pattern is formed, and the inner machinery is fixed; and a meter case to accommodate them.

Each index on the dial plate described above is made by, for example, printing nothing on a design pattern corresponding to the index so as to make the index transparent, and printing the rest in black so as to make the rest opaque. Further, by transmitting light through the design pattern from a light bulb arranged in a meter case (at a back of the dial plate), the index is so illuminated brightly that a driver can see the index.

Each time when an arrangement of each design pattern on the dial plate is changed, or a shape or a size of the dial plate is changed for changing the design of the display apparatus for a vehicle, it is necessary to produce a new dial plate, and also produce other components of the display apparatus, such as a new frame member and a new substrate. Therefore, there has been a problem that a production cost increases when the design of the display apparatus is changed.

To solve above described problem, some of the display apparatuses include an image display device such as a liquid crystal display, or an organic EL (Electro Luminescence) device disposed wholly or partially at a front side thereof. In such a display apparatus, the display device displays a warning, an indicator, a shift position of an automatic transmission, and the like.

Further, there has been suggested a display apparatus for giving a newly visual effect to a vehicle driver. In such a display apparatus for a vehicle, a transparent cover is spaced from a dial plate at a front side of the dial plate, and small displaying parts are arranged on the transparent cover in a manner as to seem to float above the dial plate. Thus, the newly visual effect having a spatial effect has been offered. (see patent application document: JP, 2004-132756, Y).

However, since such a display apparatus for a vehicle as disclosed in the document above has a complex structure, uses a number of components, and reduces workability of assembly, the display apparatus becomes expensive. Therefore, it is difficult for a vehicle in a low price range to use the display apparatus even if a vehicle in a high price range can use the same.

FIG. 5 shows an example of analog pointer meter images displayed on the display apparatus. In the motor vehicle industry, it is examined that the same display apparatus 1 can be used in a several vehicle types by displaying a meter image corresponding to the vehicle type on the display device 5 as shown in FIG. 5.

However, a display surface of such a display device 5 is dark when the display apparatus 1 is not powered. Further, a design in an unpowered condition cannot be expressed by only arranging the display device 5 in the display apparatus 1 and displaying the vehicle speed, the engine revolutions, and the like, because nothing can be seen on the display device after powering off the display apparatus 1. Namely, when powering off the display apparatus 1, since the display apparatus 1 has no spatial effect, and looks like a monitor of a personal computer, it is difficult to add a quality appearance to the display apparatus 1. Further, if the display apparatus 1 has only the display device 5, differences between the vehicle types (having different price ranges) are only made by designs and visibilities of the display device 5.

Accordingly, an object of this invention is to provide a display apparatus for a vehicle having a simple structure that differentiates vehicle types.

### SUMMARY OF THE INVENTION

In order to attain the object, according to the present invention, there is provided a display apparatus for a vehicle including:
a display device on which a state of the vehicle is displayed using a desired design pattern; and
a transparent auxiliary member being interposed between the display device and a vehicle driver, having an auxiliary design pattern corresponding to a vehicle type to form a part of the desired design pattern by superposing thereon, and allowing the vehicle driver to see superposed design pattern displayed on the display device and the auxiliary design pattern,
whereby transmitted light emitted from the display device illuminates the transparent auxiliary member.

According to the above, when the auxiliary design pattern is determined corresponding to the desired design pattern of the display device, the auxiliary design element is formed on the transparent auxiliary member corresponding to the auxiliary design pattern, and then the transparent auxiliary member is assembled in a manner as to be interposed between the vehicle driver and the display device. When the display apparatus is powered, the transparent light emitted from the display device illuminates the transparent auxiliary member, thereby a vehicle driver can see a combination of the desired design pattern and the auxiliary design pattern.

Preferably, the transparent auxiliary member has a flat transparent base, and the auxiliary design element is formed three-dimensionally on the flat transparent base.

According to the above, the transmitted light of the display device is reflected on the auxiliary design element formed spatially on the plane substrate to make the images displayed on the display device seem nearer or further to a vehicle driver. Further, when the display apparatus is not powered, outside light illuminates the spatial auxiliary design element so that the vehicle driver can see the auxiliary design element.

The above and other objects, features, and advantages of the present invention will be better understood when taken in connection with the accompanying drawings and description.

### BRIEF DESCRIPTION OF THE DRAWINGS

FIG. 1 is an exploded perspective view showing a first embodiment of a display apparatus according to the present invention;

FIG. 2 is a front view showing a transparent auxiliary member in FIG. 1;

FIG. 3 is a sectional view taken on line A-A′ in FIG. 2;

FIG. 4A is a front view showing an auxiliary design element of the display apparatus for a vehicle according to the present invention;

FIG. 4B is a sectional view taken on line B-B′ of FIG. 4A showing a second embodiment of the display apparatus for a vehicle according to the present invention;

FIG. 4C is a sectional view taken on line B-B′ of FIG. 4A showing a third embodiment of the display apparatus for a vehicle according to the present invention; and

FIG. 5 is a front view showing a conventional analog pointer image displayed on a display device of the display apparatus for a vehicle.

### DESCRIPTION OF THE PREFERRED EMBODIMENTS

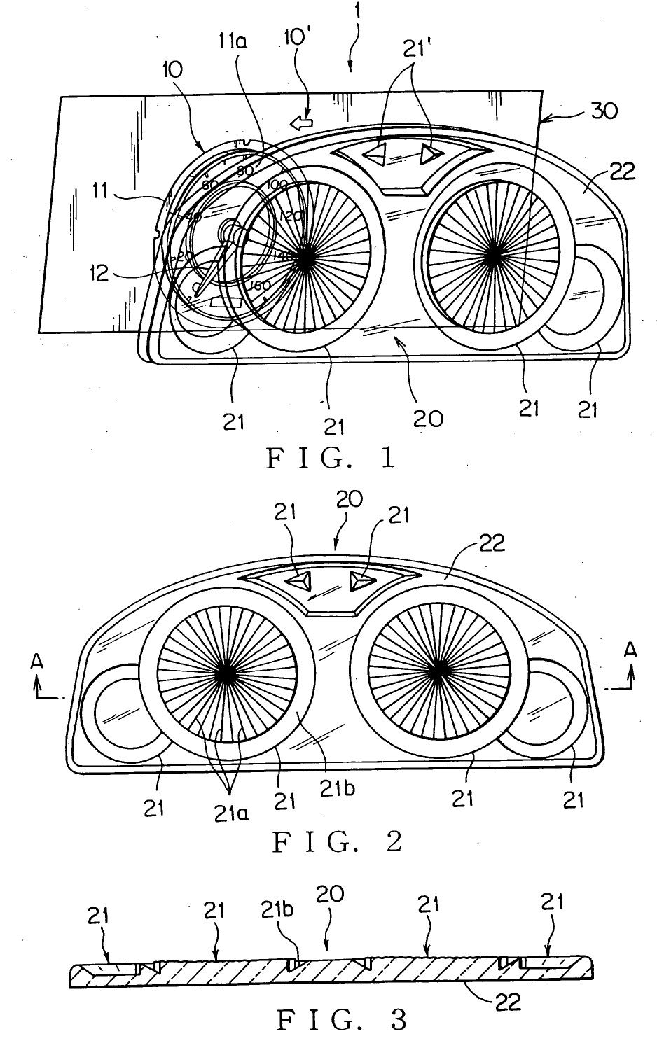

A first embodiment of a display apparatus for a vehicle according to the present invention will be described below with reference to FIGS. 1 to 4. In order to avoid repetitions, identical elements will be designated by identical reference numerals and only the differences existing in comparison with the description of the related art will be explained.

A display apparatus for a vehicle 1 is shown in FIG. 1, mounted on an instrument panel of the vehicle, and includes a display device 10 having a desired design pattern for displaying a state of the vehicle, and a transparent auxiliary member 20.

The display device 10 includes: a dial plate 11 having indexes 11a such as graduations, numbers or symbols on a surface thereof; a pointer 12 disposed in front of the dial plate 11; an inner machinery (not shown) for driving the pointer 12 corresponding to measured data; and a wiring board (not shown) on which a circuit pattern is formed, and the inner machinery is fixed.

In this embodiment, only a speedometer is shown as a display device 10 in FIG. 1 for simplifying the explanation, however, the display apparatus also includes a tachometer, a fuel meter (not shown) as the display devices 10 integrated with the speedometer and assembled on a substrate 30. The display device 10 is not limited to an analog pointer meter, but can be an LCD, or an organic EL device as image displays.

In this embodiment, since the indexes 11a and the pointer 12 on the dial plate 11 cooperate with each other to display a state of the vehicle as a vehicle speed, the indexes 11a and the pointer 12 correspond to a desired design pattern in claims. Further, if the display device 10 is an image display, an image on the display device 10 corresponds to the desired design pattern.

As shown in FIGS. 1 to 3, the transparent auxiliary member 20 is formed in a plate shape fitted to an outer shape of the instrument panel, and made of a transparent material such as transparent resin or glass. The transparent auxiliary member 20 is interposed between a vehicle driver and the display device 10 for allowing the vehicle driver to see the display device 10 and the transparent auxiliary member 20. When the display device 10 is powered, both transparent light emitted from the display device 10 and outside light illuminate the transparent auxiliary member 20. When the display device 10 is not powered, the outside light illuminates the transparent auxiliary member 20.

Incidentally, in this embodiment, the transparent auxiliary member 20 is interposed between the display device 10 and a front pane (not shown). However, other embodiments can be used, for example, the transparent auxiliary member 20 can be also used as a front pane.

An auxiliary design element 21 is formed on the transparent auxiliary member 20 in an auxiliary design pattern corresponding to a vehicle type to form a part of the desired design pattern by superposing thereon. A shape of the auxiliary design element 21 is similar to that of the display device 10, those facing each other when the transparent auxiliary member 20 is assembled. After the auxiliary design pattern in display device 10 is determined according to the desired design pattern corresponding to the vehicle type, the auxiliary design element 21 corresponding to the auxiliary design pattern is formed on the transparent auxiliary member 20.

In this embodiment, as shown in FIGS. 2 and 3, a plurality of grooves 21a of the auxiliary design element 21 are extended radially from a rotation center of the pointer 12 on the display device 10 in a manner as not to overlap the indexes 11a. Thereby, the design of the dial plate 11 seems a rising sun.

A periphery of the auxiliary design element 21 facing the indexes 11a on the dial plate 11 of the display device 10 is a circular see-through part 21b of the auxiliary design element 21. The vehicle driver can see the indexes 11a through the see-though element 21b. A unique design corresponding to the vehicle type can be formed on the see-through part 21b.

When the pointer 12 of the display device 10 is rotated corresponding to measured value, since the transmitted light reflected by the grooves 21a at the auxiliary design element 21 is changed by the pointer 12, a novel image of the rotating pointer 12 through the auxiliary design element 21 is obtained to be shown to a vehicle driver.

Next, an auxiliary design element 21′ of the transparent auxiliary member 20 corresponding to the display device 10′ displaying direction indicators will be explained.

The transparent auxiliary member 20 further includes the auxiliary design element 21′ facing the display device 10′ when assembled. The auxiliary design element 21′ is formed spatially on the plane substrate 22. In this embodiment, the auxiliary design element 21′ is formed as a triangular pyramid projected from a front wall of the substrate 22 for indicating the directions corresponding to the display device 10′. When the display device 10′ is powered, since the light emitted from the display device 10′ is transmitted through the auxiliary design element 21′, the vehicle driver can see the image with the spatial effect. Such an effect differentiates a vehicle type from others.

Next, an operation of the display apparatus for a vehicle according to this embodiment will be explained with reference to FIGS. 1 to 4A.

After the auxiliary design pattern in display device 10 is determined according to the desired design pattern corresponding to the vehicle type, the auxiliary design element 21 corresponding to the auxiliary design pattern is formed on the transparent auxiliary member 20. When the display device 10 is powered, both transparent light emitted from the display device 10 and outside light illuminate the transparent auxiliary member 20. Resultingly, the vehicle driver can see both the indexes 11a (desired design pattern) on the display device 10 and the auxiliary design element 21 on the transparent auxiliary member 20. When the display device 10 is not powered, the outside light illuminates the transparent auxiliary member 20, and a vehicle driver can see only the auxiliary design element 21.

When the display device 10′ is lighted corresponding to a left turn of a vehicle, the transmitted light of the display device 10′ is reflected on the auxiliary design element 21′ formed spatially on the plane substrate 22 to make the images displayed on the display device seem nearer or further to a vehicle driver according to a view angle between the vehicle driver and the display device 10′. Further, when the display device 10′ is not powered, outside light illuminates the spatial auxiliary design element so that the vehicle driver can see the auxiliary design element 21′.

According to the above, in the display apparatus for a vehicle 1 of the present invention, the transparent auxiliary member 20 is interposed between the display device 10 and a vehicle driver. Further, the auxiliary design element 21 to form a part of the desired design pattern of the display device 10 corresponding to the vehicle type is formed on the transparent auxiliary member 20. Further, when the display device 10 is powered, the transparent light emitted from the display device 10 illuminates the transparent auxiliary member 20, and when the display apparatus is not powered, outside light illuminates the spatial auxiliary design element. Therefore, the vehicle driver can see both the desired design pattern and the auxiliary design pattern.

Accordingly, the display apparatus for a vehicle 1 using a simple structure including the transparent auxiliary member 20 having the auxiliary design element 21 corresponding to a vehicle type differentiates a vehicle from others by vehicle type. Further, since the transparent auxiliary member 20 differentiates a vehicle by vehicle type, the display apparatus for a vehicle 1 can use the same display device 10. Thereby, the cost of the display apparatus for a vehicle 1 can be reduced. Further, display apparatus for a vehicle 1 can be mounted on various vehicles having various price ranges, by means that the display apparatus for a vehicle 1 mounted on a vehicle in a low price range includes only a display device 10, and the display apparatus for a vehicle 1 mounted on a high price range includes both the display device 10 and the transparent auxiliary member 20.

Since the auxiliary design element 21′ of the transparent auxiliary member 20 is formed spatially on the plane substrate 22, even when the display device 10′ is not powered, the outside light illuminates the auxiliary design element 21′ to show the auxiliary design element 21′ spatially to a vehicle driver. Therefore, a noble image can be offered using a combination of the desired design pattern and the spatial auxiliary design element 21′. In particular, even when the LCD having no pointer is used as the display device 10′, the transparent auxiliary member 20 of the present invention can easily differentiate a vehicle from others by vehicle type.

Incidentally, in this embodiment, the auxiliary design element 21 has a section of which thickness is substantially the same, however, this invention is not limited to this. The auxiliary design elements 21 having sections of which thicknesses are varied can be used. For example, the thickness of the section of the auxiliary design element 21 can be changed corresponding to the vehicle type.

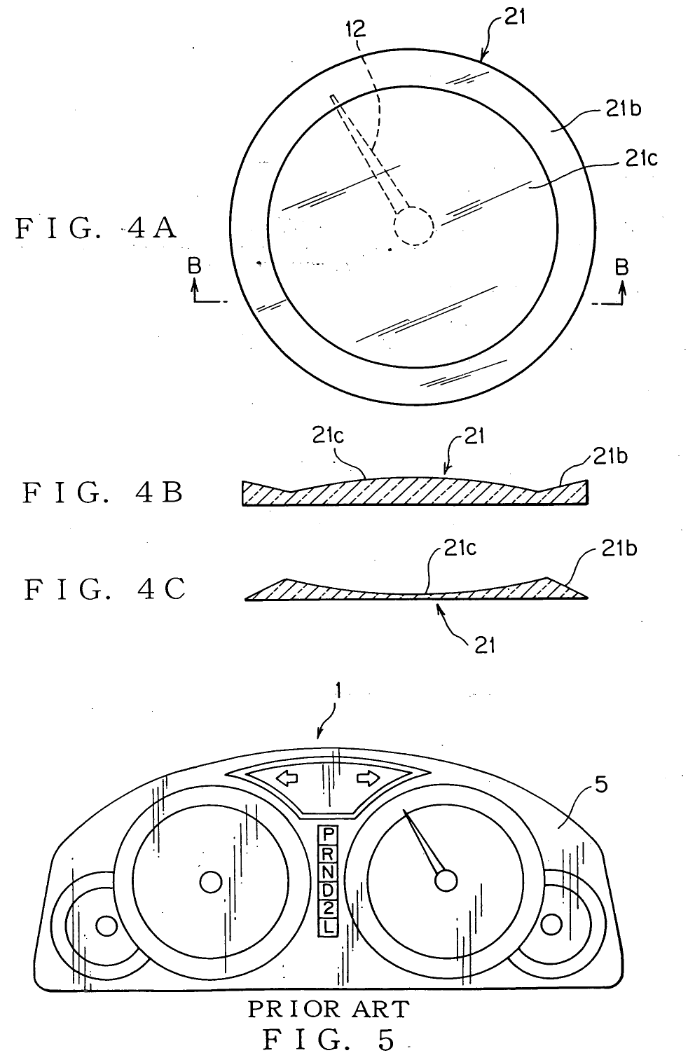

Second and third embodiments of the display apparatus for a vehicle 1 according to the present invention will be explained with reference to FIGS. 4B to 4C. As shown in FIG. 4B, the see-through part 21b is formed in a tapered shape, and a center part 21c of the auxiliary design element 21 is formed in a convex lens shape according to the second embodiment of the present invention. According to the third embodiment, as shown in FIG. 4C, a section of the see-through part 21b is formed thinner toward an edge thereof, and the center part 21c is formed in a concave lens shape. Using such an auxiliary design element 21 produces a noble image of the pointer 12 rotated around a back of the lens-shaped auxiliary design element 21. Therefore, the display apparatus for a vehicle 1 according to the second and third embodiments can further differentiate vehicle types.

Other embodiments can be used according to the present invention. For example, the auxiliary design element 21 is formed thicker from an inside of the dial plate 11 of the display device 10 toward a peripheral edge of the auxiliary design element 21 radially, so that a vehicle driver see as if the auxiliary design element 21 nearer to the peripheral edge thereof is nearer to the driver. For another example, the auxiliary design element 21 is formed thicker in a rotating direction of the pointer 12, so that a vehicle driver can notice that a state of the vehicle is more dangerous because the pointer seems to be nearer to the vehicle driver. Thus, various embodiments of the transparent auxiliary member 20 change values of the display apparatuses for a vehicle 1. Accordingly, the display apparatus for a vehicle 1 can more easily differentiate vehicle types.

According to the above, the display apparatus for a vehicle 1 can show both the desired design pattern on the display device 10 and the auxiliary design pattern of the auxiliary design element 21 on the transparent auxiliary member 20. Therefore, the display apparatus for a vehicle 1 can differentiate vehicle types by only changing the auxiliary design element 21. Therefore, the production cost of the display apparatus for a vehicle 1 is reduced.

Further, since the auxiliary design element 21 of the transparent auxiliary member 20 is formed spatially, if the image display such as an LCD is used as the display device 10, the display apparatus for a vehicle 1 can offer the noble image by the outside light even when the display device 10 is not powered.

Having now fully described the present invention, it will be apparent to one of ordinary skill in the art that many changes and modifications can be made thereto without departing from the scope of the invention as set forth herein.

What is claimed is:

1. A display apparatus for a vehicle comprising:
a display device on which a state of the vehicle is displayed using a desired design pattern; and
a transparent auxiliary member being interposed between the display device and a vehicle driver, having an auxiliary design pattern corresponding to a vehicle type to form a part of the desired design pattern by superposing thereon, and allowing the vehicle driver to see superposed design pattern displayed on the display device and the auxiliary design pattern,
whereby transmitted light emitted from the display device illuminates the transparent auxiliary member.

2. The display apparatus for a vehicle as claimed in claim 1,
wherein the transparent auxiliary member has made of a flat transparent base, and the auxiliary design element is formed three-dimensionally on the flat transparent base.
